(19) United States
(12) Patent Application Publication
(10) Pub. No.: US 2023/0414442 A1
(43) Pub. Date: Dec. 28, 2023

(54) INFLATABLE COMPRESSION WRAP

(71) Applicant: CAREMED SUPPLY INC., New Taipei City (TW)

(72) Inventor: Tsung-Hsuan LIU, Taipei City (TW)

(73) Assignee: CAREMED SUPPLY INC., New Taipei City (TW)

(21) Appl. No.: 17/850,630

(22) Filed: Jun. 27, 2022

(51) Int. Cl. A61H 9/00

(52) U.S. Cl. CPC A61H 9/0092; A61H 9/0007; A61H 2209/00

(57) ABSTRACT

An inflatable compression wrap comprises two sheet members, two bonding wires and a surrounding pattern. The sheet members are connected from each other through the surrounding pattern and the bonding wires, so that a plurality of latitudinal air chambers are formed between the sheet members. Wherein a plurality of first airbag sections and at least one second airbag section are alternately arranged in the odd sequence of the latitudinal air chambers, and at least one first airbag sections and a plurality of second airbag sections are alternately arranged in the even sequence of the latitudinal air chambers; so that the first and the second airbag sections are alternately arranged along the latitudinal direction and a longitudinal direction. When the latitudinal air chambers are inflated, the different compression forces are respectively generated by the first and second airbag section of the latitudinal air chamber to improve the blood circulation of the patient.

### FIELD OF THE INVENTION

The present invention relates to an inflatable compression wrap to improve an arterial or venous blood circulation of a patient, and more particularly, to an inflatable compression wrap that can generate different compression forces to press different positions of the patient.

### BACKGROUND OF THE INVENTION

The patient often needs to lie on sickbed after the surgery or in physically inconvenient and slow down the patient blood circulation. When the blood circulation gradually slows down, the limbs of the patient which are farther away from the heart will experience thrombosis, edema or venous embolism. In worse condition, would lead the patient's limbs to tissue necrosis.

Please refer to FIG. 1 the conventional inflatable wrap 30 that is common in the market today, can be installed on various body parts of a patient, and the conventional inflatable wrap 30 is inflated and deflated through an inflating pump 40 to ensure that the wrap can massage the muscles of various parts of the patient, thereby promoting the blood circulation of the patient. The conventional inflatable wrap 30 has a first sheet member 31 and a second sheet member 32 which has smaller outline than the first sheet member 31. The first sheet member 31 is connected to the second sheet member 32 through a surrounding bonding wire 33, so that an inflatable area 34 which is connected to the inflating pump 40 is formed between the first sheet member 31 and the second sheet member 32. Wherein, there are two bonding wires 35 located in the interior of the bonding wire 33 to connected between the first and second sheet member 31 and 32, so that the inflatable area 34 is divided into three latitudinal air chamber from top to bottom through the two bonding wires 35; a first latitudinal air chamber 341, a second latitudinal air chamber 342 and a third latitudinal air chamber 343.

As shown in the FIG. 1, in the specific conventional inflatable wrap 30 is performing some part of the muscle massage on the patient. First, the conventional inflatable wrap 30 is installed on the patient's body, and then the inflating pump 40 inflate the first, second, and third latitudinal air chambers 341, 342, and 343 of the inflatable area 34. However the first, second, and third latitudinal air chambers 341, 342, and 343 of the inflatable area 34 are all present as a long strip. Therefore, after the first, second, and third latitudinal air chambers 341, 342, and 343 are filled with gas, the conventional inflatable wrap 30 cannot laminated with some part of the patient's body, due to the part of the conventional inflatable wrap 30 cannot laminate the some part of the patient's body, so that the patient will subjectively misunderstand the massage strength of the inflatable wrap 30 on the patient is not enough. However, the patient will control the inflating pump 40 to let the inflating pump 40 provide more gas into the first, second, and third latitudinal air chambers 341, 342, and 343, which causes the first, second, and third latitudinal air chambers 341, 342, and 343 over-inflate and over-pressurize the conventional inflatable wrap 30. As a result, an over-inflated conventional inflatable wrap not only can't promote the blood circulation of the patient, but also makes the part of the patient's body feel uncomfortable.

### SUMMARY OF THE INVENTION

The primary object of the present invention is to provide an inflatable compression wrap to improve a sealing wire set, so that two sheet member are bonded from each other through the sealing wire set for forming a plurality of first airbag sections and a plurality of second airbag sections. The first airbag sections and the second airbag sections are alternately arranged along a latitudinal direction and a longitudinal direction, so that a checkerboard arrangement is presented by the first airbag sections and second airbag sections. When the inflatable compression wrap is inflated to press the patient's body, the inflatable compression wrap is fit for various body sizes of the patient to generate a suitable compression force at different positions. Whereby, the arterial or venous blood circulation of the patient will be improved by the first airbag sections and the second airbag sections, and the patient will not misunderstand the compression force of the inflatable wrap.

To achieve above object, the inflatable compression wrap includes a wrap body and a sealing wire set. The wrap body includes a first sheet member and a second sheet member, and the sealing wire set has a surrounding pattern and a plurality of bonding wires. The surrounding pattern is formed within the first sheet member and the second sheet member, so that an inflating area is formed between the first sheet member and second sheet member. The bounding wires are spaced form each other for bonding the interior of the surrounding pattern, so that a plurality of latitudinal air chambers are formed in the inflating area through the bonding wires.

A plurality of first airbag sections and at least one second airbag section are alternately arranged in the odd sequence of the latitudinal air chambers, and at least one first airbag section and a plurality of second airbag sections are alternately arranged in the even sequence of the latitudinal air chambers, wherein the first airbag sections and the second airbag sections are alternately arranged along a latitudinal direction and a longitudinal direction of the surrounding pattern, so that a checkerboard arrangement is presented by the first airbag sections and second airbag sections. Wherein, the first airbag sections and the second airbag sections are respectively provided with a first maximum wire interval and a second maximum wire interval that is unequal to the first maximum wire interval, so that the volume of the first airbag sections are different from the volume of the second airbag sections.

In a preferred embodiment, each bonding wires are sequentially provided with a left bonding segment, a middle bonding segment, and a right bonding segment. The first maximum wire interval is formed between two left bonding segments or two right bonding segments, and the second maximum wire interval is formed between two middle bonding segments.

In addition, the surrounding pattern has two longitudinal bonding wires for interlacing the bonding wires and two latitudinal bonding wires for interlacing the longitudinal bonding wires, the latitudinal bonding wires have a left latitudinal portion for aligning the left bonding segment, a middle latitudinal portion for aligning the middle bonding segment, and a right latitudinal portion for aligning the right bonding segment; the middle latitudinal portion is spaced with the middle boding segment, so that the second maximum wire interval is formed between the middle latitudinal portion and the middle bonding segment. The left latitudinal portion and the right latitudinal portion are respectively spaced with the left bonding segment and the right bonding segment, so that the first maximum wire intervals are respectively formed between the left latitudinal portion and the left bonding segment, and between the right latitudinal portion and the right bonding segment.

In another preferred embodiment, each longitudinal bonding wire is provided with a curve segment for corresponding the location of the bonding wire, and a through-hole is formed between two hollow sections of the wrap body for penetrating the first sheet member and the second sheet member, so that the curve segments are respectively located on opposite sides of the through-hole.

In an preferred embodiment, the sealing wire set further comprising a plurality of bonding points, and the plurality of bonding points are arranged in at least one of the first airbag sections or at least one of the second airbag sections, so that the shape of the first airbag section or the second airbag section is changed for reducing the height.

In the above three embodiments, the first maximum wire interval of the first airbag sections in different sequences are provided with different sizes, and the second maximum wire interval of the second airbag sections in different sequences are also provided with different sizes; in the same longitudinal direction, the length of all first maximum wire intervals are larger or smaller than the length of all second maximum wire intervals.

The present invention is characterized in that the first maximum wire interval of the first airbag section is unequal to the second maximum wire interval of the second airbag section, so that the volume of the first airbag section is different from the volume of the second airbag section. Wherein, the latitudinal air chambers in the odd sequence are formed by arranging the first airbag sections and at least one second airbag section alternately, the latitudinal air chambers in the even sequence are formed by arranging at least one first airbag section and the second airbag sections alternately. Further, the first airbag sections and the second airbag sections can alternately arrange along the latitudinal direction and the longitudinal direction of the surrounding pattern to collectively present a checkerboard arrangement. Thereby, when the inflatable compression wrap is inflated to press the patient's body, the inflatable compression wrap is fit for various body sizes of the patient to generate a suitable compression force at different positions of the patient. The arterial or venous blood circulation of the patient will be improved by the first airbag sections and the second airbag sections, and the patient will not subjectively misunderstand that the compression force of the inflatable wrap is insufficient.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a schematic view of a conventional inflatable compression wrap;

FIG. 2 is a schematic view of an inflatable compression wrap according to a first preferred embodiment of the present invention;

FIG. 3 is a schematic view of an inflatable compression wrap according to a second preferred embodiment of the present invention;

FIG. 4 is a schematic view of an inflatable compression wrap according to a third preferred embodiment of the present invention;

FIGS. 5 and 6 are a schematic view of an inflatable compression wrap according to a fourth preferred embodiment of the present invention;

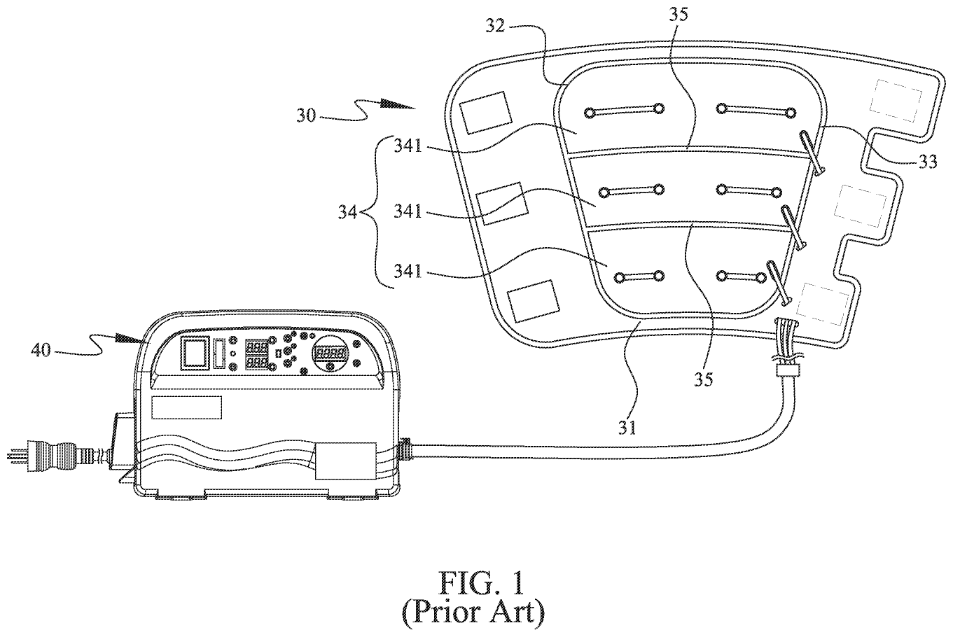

### DETAILED DESCRIPTION OF THE PREFERRED EMBODIMENTS

The present invention will now be described with a preferred embodiment thereof and by referring to the accompanying drawings. For the purpose of easy to understand, elements that are the same in the preferred embodiments are denoted by the same reference numerals.

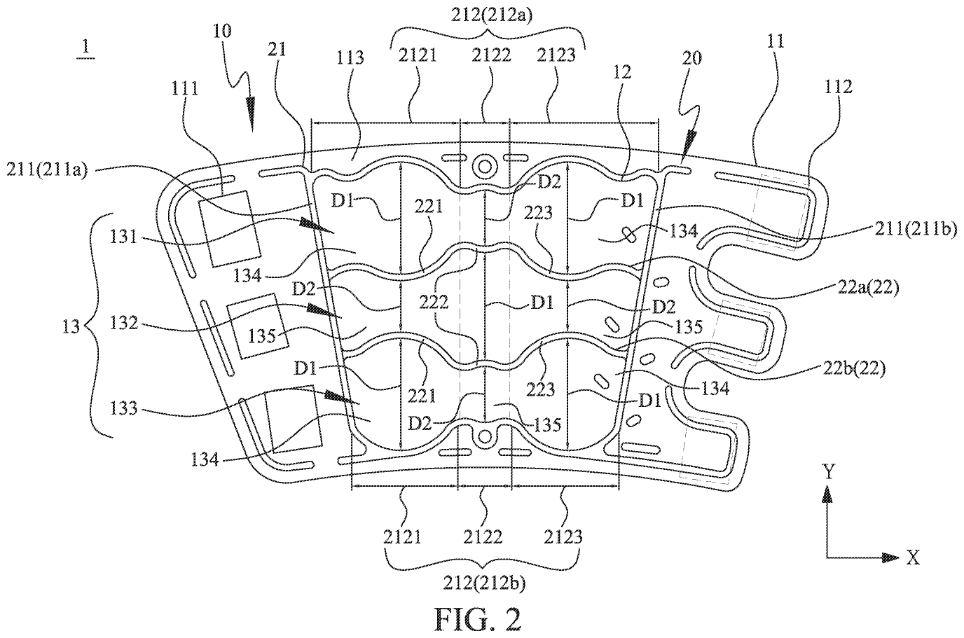

Please refer to FIG. 2. According to the first preferred embodiment, the present invention inflatable compression wrap 1 comprises a wrap body 10 and a sealing wire set 20. The wrap body 10 includes a first sheet member 11 and a second sheet member 12 that is smaller than the contour of the first sheet member 11, the opposite ends of the first sheet member 11 has a left connecting portion 111 and a right connecting portion 112 respectively, and a compression portion 13 is connected between the left connecting portion 111 and the right connecting portion 112 of the first sheet member 11. Further, the left connecting portion 111 is detachably connected with the right connecting portion 112, so that first sheet member 11 can surround the patient's body to form a loop; and the second sheet member 12 is aligned with the compression portion 113, so as the second sheet member 12 is adjacent to one side of the compression portion 113.

The sealing wire set 20 is provided with a surrounding pattern 21 and two bonding wires 22 that are spaced from each other. The surrounding pattern 21 is formed between the compression portion 113 of the first sheet member 11 and the second sheet member 12 of the wrap body 10, so that the first sheet member 11 is connected to the second sheet member 12 by surrounding pattern 21. An inflatable area 13 is formed between the first sheet member 11 and the second sheet member 12 for aligning the compression portion 113. Wherein the surrounding pattern 21 has two longitudinal bonding wires 211 and two latitudinal bonding wires 212. The longitudinal bonding wires 211 are spaced along the X-axis direction, and the latitudinal bonding wires 212 are spaced along the Y-axis direction, wherein the opposite ends of the latitudinal bonding wires 212 are respectively connected to one of the longitudinal bonding wires 211, and each latitudinal bonding wire 212 is sequentially provided with a left latitudinal portion 2121, a middle latitudinal portion 2122 and a right latitudinal portion 2123 along with the X axis. As shown of the embodiment, one of the longitudinal bonding wires 211 closing to the left connecting portion 111 of the first sheet member 11 is set as a left longitudinal bonding wire 211a, and the other of the longitudinal bonding wire 211 closing to the right connecting portion 112 of the first sheet member 11 is set as a right longitudinal bonding wire 211b. In addition, one of the latitudinal bonding wires 212 connecting to the upper side of the longitudinal bonding wires 211 is set as an upper latitudinal bonding wire 212a, and the other of the latitudinal bonding wires 212 connecting to the lower side of the longitudinal bonding wires 211 is set as a lower latitudinal bonding wire 212b.

Moreover, the opposite ends of the bonding wires 22 are respectively connected to one and the other of the longitudinal bonding wires 211, so that the surrounding pattern 21 is surround with two bonding wires 22 at the same time, and each bonding wire 22 is formed between the compression portion 113 of the first sheet member 11 and the second sheet member 12 of the wrap body 10, so that the inflatable area 13 is divided into a first latitudinal air chamber 131, a second latitudinal air chamber 132 and a third latitudinal air chamber 133 from top to bottom by the bonding wires 22; wherein each bonding wire 22 is sequentially provided with a left bonding segment 221 a middle bonding segment 222 and a right bonding segment 223 along the X-axis direction. In this embodiment, one of the bonding wires 22 adjacent to the upper horizontal bonding wire 212a of the surrounding pattern 21 is set as a first bonding wire 22a spacing the upper latitudinal bonding wire 212a, and the other one of the bonding wires 22 adjacent to the lower latitudinal bonding wire 212b of the surrounding pattern 21 is set as a second bonding wire 22b spacing the lower latitudinal bonding wire 212b.

Please refer to FIG. 2, the left latitudinal portion 2121, the middle latitudinal portion 2122 and the right latitudinal portion 2123 of the upper latitudinal bonding wire 212a are respectively aligned with the left bonding segment 221, the middle bonding segment 222 and the right bonding segment 223 of the first bonding wire 22a. In addition, the left latitudinal portion 2121, the middle latitudinal portion 2122 and the right latitudinal portion 2123 of the lower latitudinal bonding wire 212b are respectively aligned with the left bonding section 221, the middle bonding section 222 and the right bonding section 223 of the second bonding wire 22b. As shown in the figure, the inflation area 13 has a plurality of first airbag sections 134 and a plurality of second airbag sections 135. One of the first airbag sections 134 is formed between the left latitudinal portion 2121 of the upper latitudinal bonding wire 212a and the left bonding segment 221 of the first bonding wire 22a; another of the first airbag sections 134 is formed between the right latitudinal portion 2123 of the latitudinal bonding wire 212a and the right bonding segment 223 of the first bonding wire 22a; another of the first airbag sections 134 is formed between the middle bonding segment 222 of the first bonding wire 22a and the middle bonding segment 222 of the second bonding wire 22b; another of the first airbag sections 134 is formed between the left latitudinal portion 2121 of the lower latitudinal bonding wire 212b and the left bonding segment 221 of the second bonding wire 22b; the other of the first airbag sections 134 is formed between the right latitudinal portion 2123 of the lower latitudinal bonding wire 212b and the right bonding segment 223 of the second bonding wire 22b.

One of the second airbag sections 135 is formed between the middle latitudinal portion 2122 of the upper latitudinal bonding wire 212a and the middle bonding segment 222 of the first bonding wire 22a; another of the second airbag sections 135 is formed between the left bonding segment 221 of the first bonding wire 22a and the left bonding segment 221 of the second bonding wire 22b; another of the second airbag sections 135 is formed between the right bonding segment 223 of the first bonding wire 22a and the right bonding segment 223 of the second bonding wire 22b; and the other of the second airbag sections 135 is formed between the middle latitudinal portion 2122 of the lower latitudinal bonding wire 212b and the middle bonding segment 222 of the second bonding wire 22b.

Therefore, the inflatable area 13 is provided with one first airbag section 134 and one second airbag section 135 at the opposite sides of the left bonding segment 221, the middle bonding segment 222 and the right bonding segment 223, so that the first latitudinal air chambers 131 and the third latitudinal air chambers 133 are sequentially constructed of the first airbag section 134, the second airbag section 135 and the first airbag section 134 along the X-axis direction, and the second latitudinal air chambers 132 is sequentially constructed of the second airbag section 135, the first airbag section 134, and the second airbag section 135 along the X-axis direction. Therefore, the first airbag sections 134 and the second airbag sections 135 can be alternately arranged along the latitudinal direction (X-axis direction) and the longitudinal direction (Y-axis direction) of the surrounding pattern 21, so that a checkerboard arrangement is collectively presented by the first airbag sections 134 and the second airbag sections 135.

The first airbag section 134 and the second airbag section 135 respectively have a first maximum wire interval D1 and a second maximum wire interval D2. In this embodiment, the length of the first maximum wire interval D1 is larger than the length of the second maximum wire interval D2, so that the volume of the first airbag section 134 is larger than the volume of the second airbag section 135. When the inflatable compression wrap 1 is inflated to press the patient's body, the first airbag section 134 and the second airbag section 134 of the inflatable compression wrap 1 will generate different compression forces to improve the blood circulation of the patient. In the meantime, the inflatable compression wrap 1 will fit for the patient body and the patient will not subjectively misunderstand that the compression force is insufficient.

In this embodiment, the first maximum wire interval D1 of the first airbag sections 134 in different sequences are provided with different sizes, and the second maximum wire interval D2 of the second airbag sections 135 in different sequences are also provided with different sizes; in the same longitudinal direction, the length of all first maximum wire intervals D1 are larger than the length of all second maximum wire intervals D2.

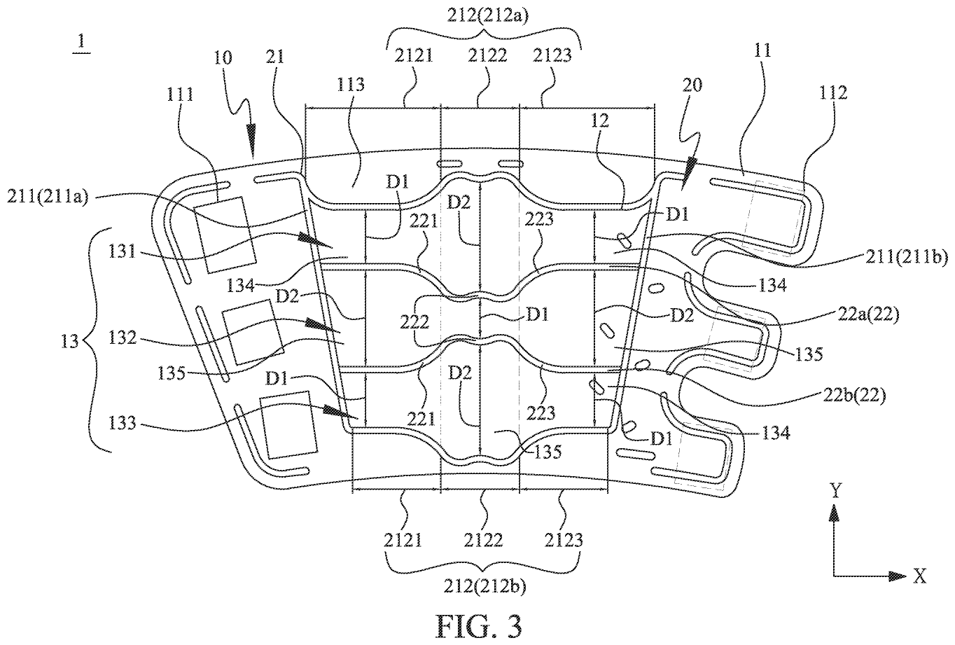

Please refer to FIG. 3, in the second preferred embodiment, the difference between the second preferred embodiment and the first preferred embodiment is that the length of the first maximum wire interval D1 is smaller than the length of the second maximum wire interval D2, and the structure of the wrap body 10 and the sealing wire set 20 in the second preferred embodiment are the same the first preferred embodiment. Furthermore, the structure of the second embodiment will not be describe repeatedly. In second embodiment, the length of the first maximum wire interval D1 is smaller than the length of the second maximum wire interval D2, so that the volume of the first airbag section 134 is smaller than the volume of the second airbag section 135, that makes the first airbag sections 134 and the second airbag sections 135 together present another checkerboard arrangement that different from the first embodiment, and in the same longitudinal direction, the length of all first maximum wire interval D1 must be smaller than the length of all second maximum wire interval D2.

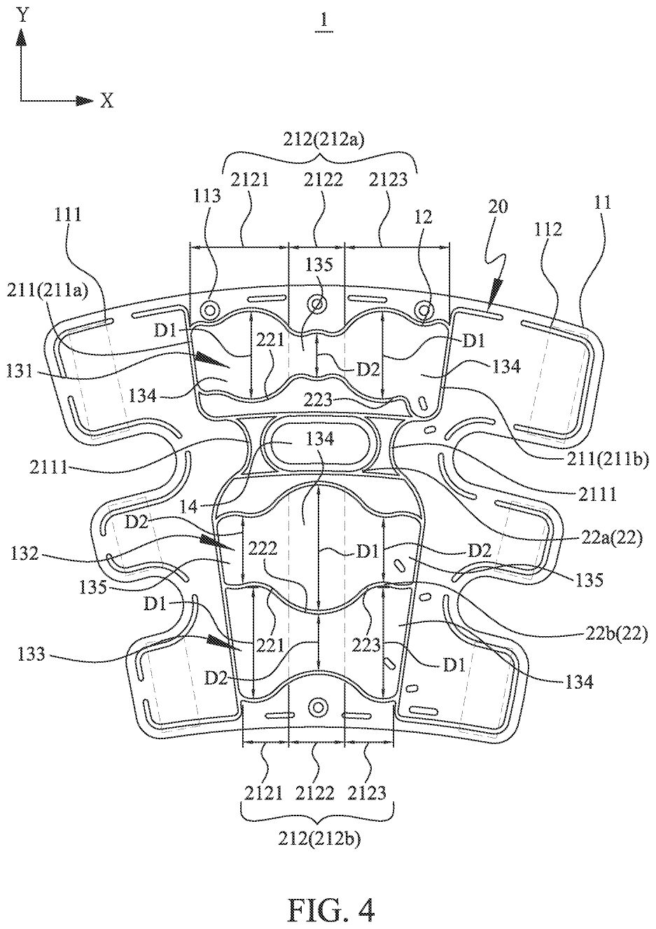

Please refer to FIG. 4, in the third preferred embodiment, the difference between the third preferred embodiment and the first preferred embodiment is the structure of the wrap body 10 and the sealing wire set 20. As shown, the wrap body 10 is provided with a through-hole 14 close to the first bonding wire 22a for penetrating the first sheet member 11 and the second sheet member 12, and the longitudinal bonding wires 211 of the sealing wire set 20 are provided with a curve segment 2111 for aligning the position of the first bonding wire 22a; so that the through-hole 14 is located between the two curve segments 2111 and the two curvet segments 2111 are located on opposite sides of the through-hole 14 respectively.

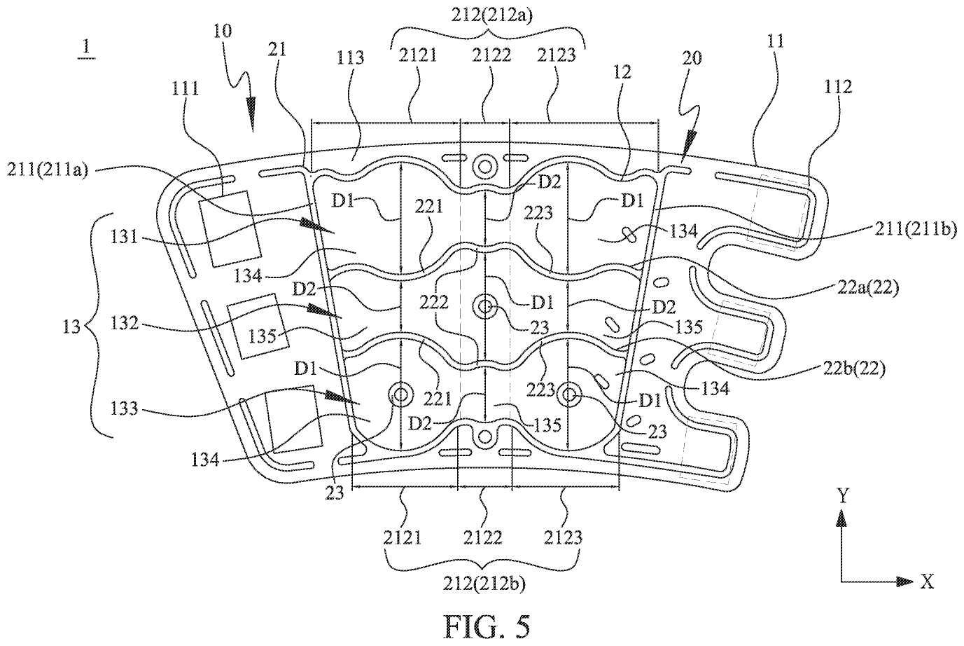

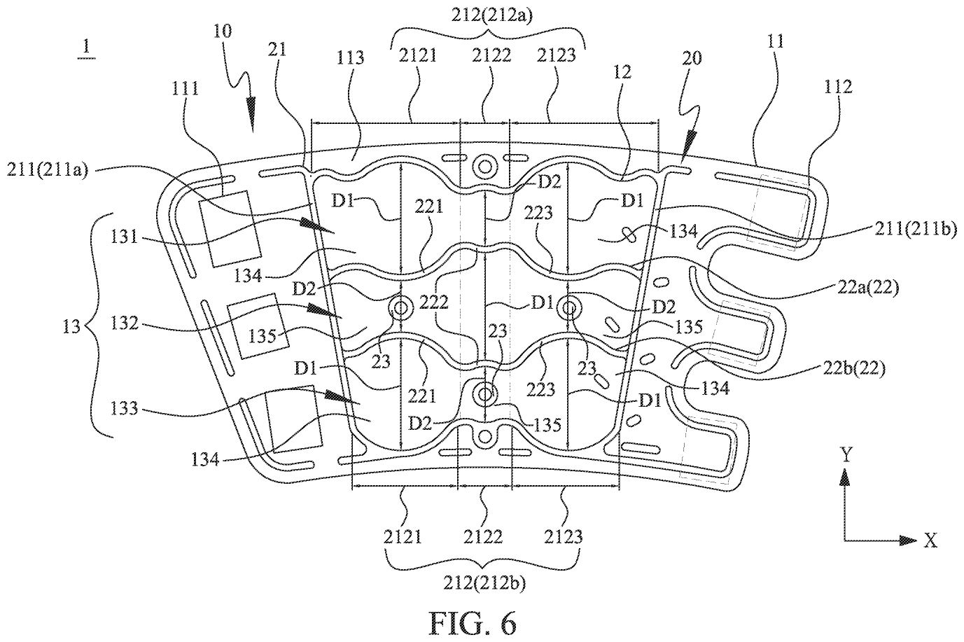

Please refer to FIG. 5 and FIG. 6, in the fourth preferred embodiment, the difference between the fourth preferred embodiment and the first preferred embodiment is the sealing wire set 20. as shown in FIG. 5, the sealing wire set 20 further comprises a plurality of bonding points 23, the bonding points 23 are respectively arranged one-to-one at the first airbag sections 134. In other embodiment, the bonding points 23 are respectively arranged one-to-one at the second airbag sections 135 as shown in FIG. 6, so that the shape of the first airbag sections 134 or the second airbag sections 135 can be changed by the bonding points 23 for reducing the height of the air sections.

What is claim is:

1. An inflatable compression wrap comprise;
a wrap body included a first sheet member and a second sheet member; and
a sealing wire set included a surrounding wire and a plurality of bonding wires, the surrounding pattern is formed within the first sheet member and the second sheet member, so that an inflating area is formed between the first sheet member and second sheet member. The bounding wires are spaced from each other for bonding the interior of the surrounding pattern, so that a plurality of latitudinal air chambers are formed in the inflating area through the bonding wires;
characterized in that: a plurality of first airbag sections and at least one second airbag section are alternately arranged in the odd sequence of the latitudinal air chambers; and
at least one first airbag section and a plurality of second airbag sections are alternately arranged in the even sequence of the latitudinal air chambers;
wherein the first airbag sections and the second airbag sections are alternately arranged along a latitudinal direction and a longitudinal direction of the surrounding pattern, so that a checkerboard arrangement is presented by the first airbag sections and second airbag sections; wherein the first airbag sections and the second airbag sections are respectively provided with a first maximum wire interval and a second maximum wire interval that is unequal to the first maximum wire interval, so that the volume of the first airbag sections are different from the volume of the second airbag sections.

2. The inflatable compression wrap as claimed in claim 1, wherein each bonding wire is sequentially provided with a left bonding segment, a middle bonding segment, and a right bonding segment;
the first maximum wire interval is formed between two left bonding segments or two right bonding segments, and the second maximum wire interval is formed between two middle bonding segments.

3. The inflatable compression wrap as claimed in claim 2, wherein the surrounding pattern has two longitudinal bonding wires for interlacing the bonding wires and two latitudinal bonding wires for interlacing the longitudinal bonding wires, the latitudinal bonding wires have a left latitudinal portion for aligning the left bonding segment, a middle latitudinal portion for aligning the middle bonding segment, and a right latitudinal portion for aligning the right bonding segment; the middle latitudinal portion is spaced with the middle boding segment, so that the second maximum wire interval is formed between the middle latitudinal portion and the middle bonding segment.

4. The inflatable compression wrap as claimed in claim 3, wherein the left latitudinal portion and the right latitudinal portion are respectively spaced with the left bonding segment and the right bonding segment, so that the first maximum wire intervals are respectively formed between the left latitudinal portion and the left bonding segment, and between the right latitudinal portion and the right bonding segment.

5. The inflatable compression wrap as claimed in claim 3, wherein each longitudinal bonding wire is provided with a curve segment for corresponding the location of the bonding wire, and a through-hole is formed between two hollow sections of the wrap body for penetrating the first sheet member and the second sheet member, so that the curve segments are respectively located on opposite sides of the through-hole.

6. The inflatable compression wrap as claimed in claim 1, the sealing wire set further comprising a plurality of bonding points, and the plurality of bonding points are arranged in at least one of the first airbag sections or at least one of the second airbag sections, so that the shape of the first airbag section or the second airbag section is changed for reducing the height.

7. The inflatable compression wrap as claimed in claim 1, wherein the first maximum wire interval of the first airbag sections in different sequences are provided with different sizes, and the second maximum wire interval of the second airbag sections in different sequences are also provided with different sizes; in the same longitudinal direction, the length of all first maximum wire intervals are larger or smaller than the length of all second maximum wire intervals.
